(19) United States
(12) Patent Application Publication
(10) Pub. No.: US 2026/0163863 A1
(43) Pub. Date: Jun. 11, 2026

(54) Monitoring Tenant Container Executed within Secure Environment

(71) Applicant: Telefonaktiebolaget LM Ericsson (publ), Stockholm (SE)

(72) Inventors: Lina Pålsson, Genarp (SE); Henrik Normann, Malmö (SE); Helen Örtenblad, Göteborg (SE); Mikael Eriksson, Alingsås (SE)

(21) Appl. No.: 19/123,571

(22) PCT Filed: Nov. 14, 2022
(86) PCT No.: PCT/EP2022/081737

§ 371 Date: Apr. 23, 2025

(51) Int. Cl. H04L 9/40; G06F 21/62; G06F 21/74

(52) U.S. Cl. CPC H04L 63/0227; G06F 21/6245; G06F 21/74; H04L 63/1408

(57) ABSTRACT

Embodiments of the present disclosure provide a method (300) for monitoring a tenant container (80) executed within a secure environment (90) resident on a computing device (102), the tenant container holding information related to the tenant container. The method (300) is performed by a collection agent (60) within the tenant container (80). The method (300) comprises obtaining (302) configuration information identifying which information related to the tenant container (80) is to be collected within the secure environment (90) and transmitted from the secure environment (90). The method (300) comprises collecting (304), in accordance with the configuration information, the information related to the tenant container (80) during execution of one or more processes (70) of the tenant container (80) within the secure environment (90). The method (300) comprises filtering (306) the collected information related to the tenant container (80). The method (300) comprises transmitting (308) the filtered information to at least one network entity (104). Corresponding computing device, and computer program products are also disclosed.

### TECHNICAL FIELD

The present disclosure relates generally to the field of cloud security systems. More particularly, it relates to method, computing device and computer program products for monitoring a tenant container executed within a secure environment.

### BACKGROUND

Traditionally network functions representing a cellular network have been represented by physical devices. For example, a dedicated hardware has been deployed for a certain network function or for a set of network functions. Over time, a concept of virtualization has been emerged in parallel with emergence of fifth generation, 5G, networks. The virtualization involves a transition of the network function from the dedicated hardware to commercial of a shelf hardware, thereby providing flexibility for both scaling and hosting of the network functions.

Further, clause 8 in “Network Functions Virtualisation (NFV) Use Cases” from European Telecommunications Standards Institute, ETSI, standards describes transformation of use cases that are enabled by the virtualization. One of the use cases is that companies used to purchase a dedicated hardware and host machines themselves can nowadays purchase a functionality packed as containers. For example, the functionality corresponds to the network functions of the cellular network.

With the emergence of the virtualization, various mechanisms for providing virtualized computing resources are evolving. For instance, container technologies and corresponding container clustering platforms are emerging as a solution for implementing flexible and scalable application virtualization mechanisms. In such mechanisms, the network functions/any other applications may be implemented using a set of containers, for example, with different functions that are provisioned on a set of computing resources. The computing resources can be physical computing resources or virtual computing resources such as virtualized in a data center or multiple data centers or container clustering platforms.

Usage of containers is a method of virtualization of computers or, more specifically, computer software applications. A container separates the application from an operating system and a physical infrastructure it uses to connect to a computing network. Containers are known for rapid provisioning within clusters and cloud environments. For example, Docker is an open platform container for developers and system administrators to build and run distributed applications as containers.

Typically, the container refers to a software package that may be executed in a computing device. The container may be provided as a service which is commonly referred to container as a service, CaaS, in which an organization provides runtime and resources for another organization to deploy their container(s) in a public cloud. The organization hosting the containers may be known as a cloud service provider, CSP, or an infrastructure provider. In some examples, the CSP/infrastructure provider may be a hyperscale provider, a communication service provider, or part of an organization that has the container to deploy. The organization that provides the container to the CSP is typically referred to as a tenant. The CSP can host and execute many containers producing a lot of valuable information. Some of the information the containers produce are metadata and general logging while other information within the containers may be sensitive. Further, an organization providing the containers to the tenant is typically referred as a vendor of the container. In some examples, the tenant may include a mobile network operator, MNO.

An Extended Berkeley Packet Filter, eBPF technology may be used to collect information from the container. The eBPF technology may execute sandbox programs in a Linux kernel to collect information from the container. A strength of the eBPF technology is that the information can be collected from the container without affecting a behaviour of the kernel or without changing the kernel itself or without affecting the kernel by adding kernel modules. The eBPF technology is well suited for collecting information related to the container both from user space and kernel space with help of probes. Also, endpoint detection and response, EDR, systems including cloud native runtime security systems are also powered by the eBPF technology rather than the kernel modules, since the eBPF technology provides advantages in stability and flexibility. Using the eBPF technology, one or more probes can be enabled on the container to collect the information from the container before encryption at a sender's side or after decryption at a recipient's side. In some instances, the one or more probes may collect the information related to the container without an intent of the container. The collected information related to the container may be used in an unauthorized manner.

In order to secure collection of the information of the container, execution of the container can be moved into a secure environment. In some examples, the secure environment can be a trusted execution environment, TEE, which stores and protects the information of the container, which is original and unaltered information.

In some examples, the TEE environment can be used in such manner that the whole of, or part of, the container image to be populated is encrypted by the vendor of the container image and will only be decrypted inside of the trusted environment, for instance after authentication made by the vendor of the container image. This enables the vendor of the container image to keep their IPR's unrevealed also from the instance executing the container.

Some exemplary debugging and visibility tools are available for monitoring collection of the information from the container by the one or more probes enabled on the container. However, such debugging and visibility tools may not be able to monitor collection of the information from the container, when the container or a main part of the container's functionality is moved to be executed inside the secure environment.

Even if vendor specific debugging and visibility tools or implementations in the secure environment achieve monitoring of collection of the information of the container, MNO's popularity of vendor agnostic observability solution has showed that a single solution, which the MNO may use with all their containers independently of the vendor is often preferred by the MNO. Further, the EDR systems also work vendor independently in a non-secure environment, since the EDR systems act from the host. Even if the need of the debugging and visibility tools in the secure environment can be considered as less, the debugging and visibility tools can be potentially needed in a future when attacks are targeted on the secure environment or processes/codes running in the secure environment.

### SUMMARY

It is important to monitor the container being executed within the secure environment. If the sensitive information related to the container is extracted and transmitted from the secure environment while execution of the container within the secure environment, protection provided by the secure environment may be ruined.

In addition, in a service-based architecture, SBA, model with different network functions provided by the different vendors, vendor independence of monitoring collection of the information of the container is also needful.

Consequently, there is a need for an improved method and arrangement for monitoring a container being executed within a secure environment that alleviates at least some of the above-cited problems.

It is therefore an object of the present disclosure to provide a method, a computing device, and a computer program product for monitoring a tenant container executed within a secure environment, to mitigate, alleviate, or eliminate all or at least some of the above-discussed drawbacks of presently known solutions.

This and other objects are achieved by means of a method, a computing device, and a computer program product as defined in the appended claims. The term exemplary is in the present context to be understood as serving as an instance, example or illustration.

According to a first aspect of the present disclosure, a method for monitoring a tenant container executed within a secure environment resident on a computing device is provided.

The tenant container holds information related to the tenant container and the method is performed by a collection agent within the tenant container. The method comprises obtaining configuration information identifying which information related to the tenant container is to be collected within the secure environment and transmitted from the secure environment. The method comprises collecting, in accordance with the configuration information, the information related to the tenant container during execution of one or more processes of the tenant container within the secure environment. The method comprises filtering the collected information related to the tenant container. The method comprises transmitting the filtered information to at least one network entity.

In some embodiments, the step of obtaining the configuration information comprises identifying, from a set of predetermined configuration rules, one or more configuration settings to be applied for collection, filtering and transmission of the information.

In some embodiments, the set of predetermined configuration rules are received from one or more of: one or more network entities, an internal source residing within the secure environment, and at least one external entity in communication with the computing device.

In some embodiments, the method further comprises authenticating the at least one external entity using credentials of approved external entities for receiving the set of predetermined configuration rules.

In some embodiments, the step of receiving the set of predetermined configuration rules from the one or more network entities comprises receiving, from a first network entity, at least one predetermined configuration rule and receiving, from a second network entity, adaptations to the at least one predetermined configuration rule received from the first network entity.

In some embodiments, the set of predetermined configuration rules comprises an information type of the information related to the tenant container to be collected, information identifying at least a part of the collected information to be filtered, and information identifying the at least one network entity for transmission of the filtered information.

In some embodiments, the information type defines one or more of: information shared internally among the one or more processes, information inflowing and leaving the secure environment, information about access control violation of the tenant container, information about unexpected network access of the tenant container, information about unexpected execution in the tenant container, information about unexpected write in the tenant container, and information about unexpected access rights in the tenant container.

In some embodiments, the information type is an internal information defined within the collection agent, wherein the configuration, enabling or disabling of collection of the internal information is indicated in the configuration information.

In some embodiments, the information type is an input of information collected inside the tenant container, external to the collection agent.

In some embodiments, the method further comprises deriving configuration settings for collection, filtering and transmission of the information related to the tenant container from the secure environment using at least one of: the configuration rules identified to be applied for collection, filtering and transmission of the information and one or more attributes.

In some embodiments, the configuration settings comprise collection settings for collecting the information related to the tenant container, filtering settings for filtering the collected information, and transmission settings for transmission of the filtered information.

In some embodiments, the one or more attributes comprise one or more of: an identity, a location, and an owner of at least one of: the at least one network entity, the computing device, and a remote device in connection between the computing device and the at least one network entity, tags and/or structure of the information to be collected, a functionality of the tenant container, a functionality of the one or more processes of the tenant container, and a time and a date.

In some embodiments, the step of collecting the information related to the tenant container comprises identifying the information type of the information related to the tenant container to be collected using the derived collection settings, and collecting the identified information type of the information related to the tenant container.

In some embodiments, the step of filtering the collected information related to the tenant container comprises identifying at least a part of the collected information to be filtered using the derived filtering settings and filtering the identified information.

In some embodiments, the method further comprises determining, using the derived transmission settings, the at least one network entity for transmission of the filtered information.

In some embodiments, the method further comprises determining whether to transmit the collected information to be filtered at an external entity authenticated by the computing device. When it has been determined to transmit the collected information, the method comprises transmitting the collected information with the configuration rules to be applied for filtering of the collected information and the attributes to the external entity for filtering.

In some embodiments, the step of transmitting the filtered information comprises identifying the at least one network entity for transmission of the filtered information using the derived transmission settings and transmitting the filtered information to the identified at least one network entity.

In some embodiments, the step of transmitting the filtered information to the identified at least one network entity comprises encrypting the filtered information for transmitting to the at least one network entity.

In some embodiments, the method comprises determining whether the at least one network entity requires verification of the tenant container and/or the secure environment for receiving the information related to the tenant container from the secure environment. When it has been determined that the at least one network entity requires verification, transmitting an identity of the tenant container or an identity of the secure environment to the at least one network entity.

In some embodiments, the at least one network entity comprises one or more of: a container vendor associated with the tenant container, a tenant, one or more processes external to the secure environment and being executed by the computing device, and at least one external entity authenticated by the container vendor and/or the tenant.

According to a second aspect of the present disclosure, a computing device for monitoring a tenant container executed within a secure environment resident on the computing device is provided. The tenant container holds information related to the tenant container and the computing device is adapted for executing a collection agent within the tenant container. The computing device is adapted for obtaining configuration information identifying which information related to the tenant container is to be collected within the secure environment and transmitted from the secure environment. The computing device is adapted for collecting, in accordance with the configuration information, the information related to the tenant container during execution of one or more processes of the tenant container within the secure environment. The computing device is adapted for filtering the collected information related to the tenant container. The computing device is adapted for transmitting the filtered information to at least one network entity.

According to a third aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

According to a fourth aspect of the present disclosure, there is provided a computer program comprising instructions which, when the computer program is executed by a computer, cause the computer to carry out the method according to any of the first aspect.

In some embodiments, any of the above aspects may additionally have features identical with or corresponding to any of the various features as explained above for any of the other aspects.

An advantage of some embodiments is that alternative and/or improved approaches are provided for monitoring the collection, filtering and transmission of information related to the tenant container leaving the secure environment.

An advantage of some embodiments is that the information related to the tenant container being executed within the secure environment is collected, filtered and transmitted to at least one network entity using configuration information, which identifies the information to be collected and transmitted from the secure environment. As a result, the information related to the tenant container may be pruned from sensitive information before leaving the secure environment.

An advantage of some embodiments is that the configuration information is received from at least one of: a container vendor and a tenant (for example, a mobile network operator, MNO). Thus, the tenant is provided with configuration capabilities for extraction of the information related to the tenant container from the secure environment while simultaneously protecting container vendor sensitive information.

An advantage of some embodiments is to achieve an equilibrium between the container vendor and the tenant, so that the container vendor may protect the information related to the tenant container which includes sensitive information and may specify the at least one network entity for reception of the information. At the same time, the tenant may configure extraction of the information from the tenant container inside the secure environment and the at least one network entity for the extracted information, in accordance with its specific requirements while retaining the benefits of the secure environment.

An advantage of some embodiments is to enable several kinds of observability functionality in the secure environment which gives the possibility to use single observability solution for different kind of data collections on different kinds of containers. A first observability functionality includes analyzing internal behavior of the tenant container, like suspicious file writes or network connections and a second observability functionality includes providing information in clear text on what information to be transmitted between transport layer security, TLS, protected tenant containers. Further, the observability functionalities can be added specific for the specific functionality that the container is implementing. Thus, the actual data collection is specific to that container. The result of each data collection comprises a third kind of observability functionality which can be handled in the same manner as the other two described kinds of observability functionality.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1A and 1B disclose a block diagram illustrating examples of computing devices connected to a network according to some examples;

FIGS. 2A and 2B disclose an example implementation for monitoring a tenant container executed within a secure environment resident on a computing device according to some examples;

FIG. 3 is a flowchart illustrating example method steps according to some examples;

FIGS. 4A and 4B disclose example illustrations of configuration information received from a container vendor and a tenant for collection, filtering and transmission of information from a secure environment according to some examples;

FIG. 5 is a signaling diagram illustrating example signaling according to some examples;

FIG. 6 is a signaling diagram illustrating example signaling according to some examples; and

FIG. 7 discloses an example computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

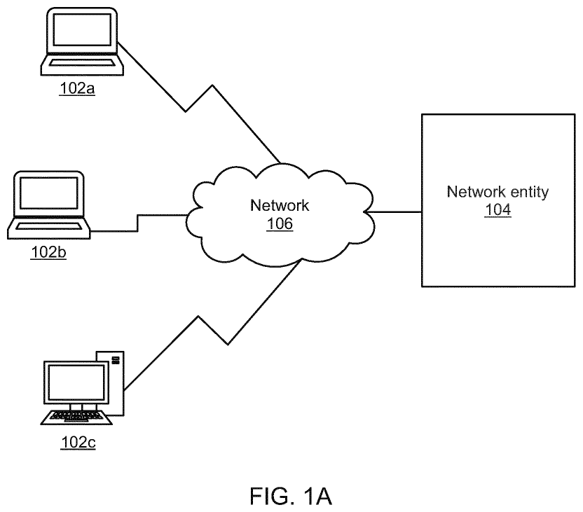

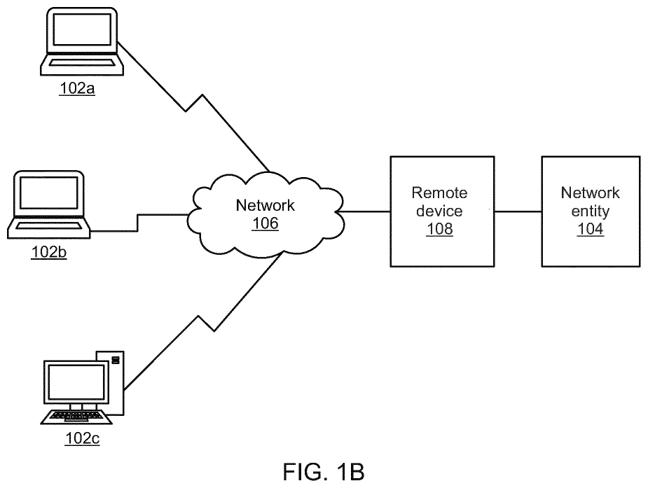

FIGS. 1A and 1B disclose a block diagram illustrating computing devices connected to a network. As depicted in FIGS. 1A and 1B, there may be a plurality of computing devices 102a, 102b, and 102c connected to a network 106. Further, there exists at least one network entity 104, which communicates with the computing devices 102a, 102b, and 102c. In some examples, as depicted in FIG. 1A, the at least one network entity 104 may communicate with the computing devices 102a, 102b, and 102c over the network 106. The network 106 referred herein may be, for example, an informational technology network, an operational technology network, a cloud infrastructure, a software as a service, SaaS, infrastructure or any combination thereof. In some examples, as depicted in FIG. 1B, the at least one network entity 104 may communicate with the computing devices 102a, 102b, and 102c through a remote device 108 (also be referred to as intermediator). The remote device 108 may communicate with the computing devices 102a, 102b, and 102c over the network 106.

In some examples, the computing devices 102a, 102b, and 102c (collectively referred to as a computing device 102) may include, but are not limited to, a server, an electronic device, a multi-processor system, a microprocessor-based or programmable consumer electronic device, a network computing device, or a combination thereof. The electronic device may include a cellular phone, a personal digital assistant, PDA, a handheld device, a laptop computer, or a combination thereof.

The computing device/hosting device 102 is configured to host a secure environment within which one or more tenant containers being executed. In some examples, the secure environment may be a trusted execution environment, TEE. The one or more tenant containers (or at least some of them) are hosted or configured by a cloud service provider, CSP, and/or the at least one network entity 104. In some examples, network functions, NFs, or virtual network functions, VNFs, or the like, representing a cellular network may be implemented using the tenant container. The tenant container comprises one or more processes, which have been executed within the secure environment to generate information. In some examples, the processes may include libraries implementing transport layer security, TLS. In some examples, the information (also be referred to as data, data stream, input stream, data packets, or the like) may include, but are not limited to, metadata, general logging, sensitive/valuable information, and so on. In some examples, sensitive/valuable information may include personal identification information, PII, intellectual property right, IPR, related information, or the like. Further, the tenant container may include different functionalities that are provisioned on a set of computing resources. In some examples, the computing resources may include physical computing resources, or virtual computing resources such as virtualized in a data center or multiple data centers or container clustering platforms.

In some examples, the at least one network entity 104 (also referred to as data consumer) may include one or more of: a container vendor associated with the tenant container, a tenant, one or more processes external to the secure environment and being executed by the computing device, at least one external entity authenticated by the container vendor and/or the tenant, and so on. The container vendor may be an organization providing the tenant container to the tenant. In some examples, the container vendor may develop the NFs or the VNFs, which may be implemented using the tenant containers inside the secure environment. The tenant may be an organization providing the tenant container to the CSP. The CSP/infrastructure provider may be a hyperscale provider, a communication service provider, or part of an organization that has the tenant containers to deploy. In some examples, the tenant may include a mobile network operator, MNO. In some examples, the at least one external entity may include a server, a computing device, an electronic device, a multi-processor system, a microprocessor-based or programmable consumer electronic device, a network computing device, or a combination thereof. The electronic device may include a cellular phone, a personal digital assistant, PDA, a handheld device, a laptop computer, or a combination thereof.

In some examples, the remote device 108 referred herein may be an intermediate node present in between the computing device 102 and the at least one network entity 104. In some examples, the remote device 108 may include the at least one external entity provided by the same or the different network entity 104/provider implemented the tenant container within the secure environment.

The computing device 102 collects the information related to tenant container, when the tenant container is executed within the secure environment. The computing device 102 transmits the collected information to the at least one network entity 104 from the secure environment. If the information transmitted to the at least one network entity 104 includes sensitive information that has not been intended for the at least one network entity 104, then protection of the secure environment may be ruined. However, there are no solutions available for monitoring collection, filtering and transmission of the information related to the tenant container from the secure environment.

Therefore, the computing device 102 implements a method for monitoring the tenant container executed within the secure environment resident on the computing device 102. The method is being performed within the tenant container executed by the computing device 102. It should be noted that any of the computing devices 102a, 102b and 102c, hereinafter referred to as 102, may implement the method for securing the tenant container executed within the secure environment hosted by the computing device 102.

The computing device 102 obtains configuration information identifying which information related to the tenant container is to be collected within the secure environment and transmitted from the secure environment. In accordance with the obtained configuration information, the computing device 102 collects the information related to the tenant container during execution of the one or more processes of the tenant container within the secure environment. Upon collecting the information, the computing device 102 filters the collected information related to the tenant container. The computing device 102 transmits the filtered information to the at least one network entity 104. Thus, the information related to the tenant container may be pruned from sensitive information before leaving the secure environment.

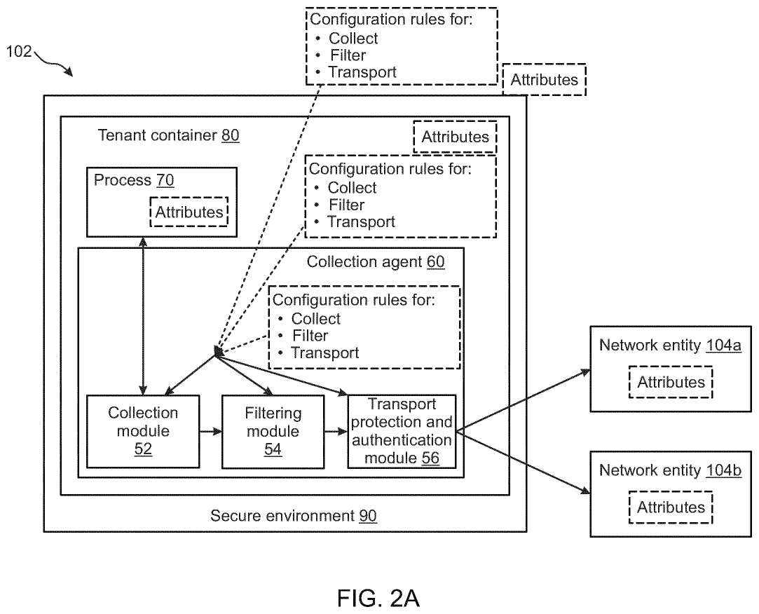

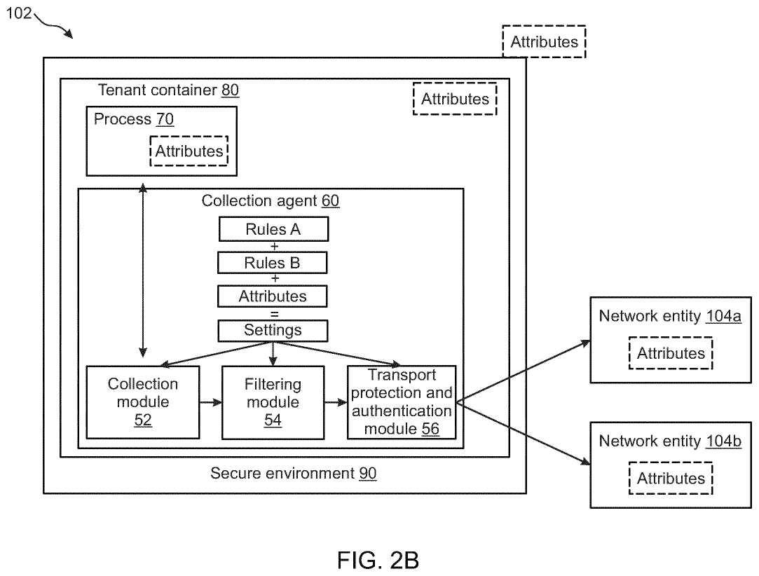

Various examples for monitoring the tenant container executed within the secure environment are explained in conjunction with figures in the later parts of the description. FIGS. 2A and 2B disclose an example implementation for monitoring the tenant container executed within the secure environment. As depicted in FIGS. 2A and 2B, the computing device 102 hosts the secure environment, for examples, TEE. The secure environment may protect execution of the tenant container 80. The tenant container 80 may comprise one or more processes, for example, a process 70, which may be executed within the secure environment to generate information. In some examples, the information (also be referred to as data, data packets, or the like) may include, but are not limited to, metadata, general logging, sensitive/valuable information, and so on.

As depicted in FIGS. 2A and 2B, there exists a collection agent 60 for monitoring collection, filtering and transmission of the information related to the tenant container 80 from the secure environment 90 to the one or more network entities 104a, and 104b (collectively referred to as the network entity 104). In some examples, the one or more network entities 104 may include at least one of: the container vendor associated with the tenant container 80, the tenant, the one or more processes external to the secure environment 90 and being executed by the computing device, and the at least one external entity authenticated by the container vendor/tenant. The external entity may be an endpoint detection and response, EDR provider or a visibility/observability tool provider.

The collection agent 60 can be the container vendor or an EDR provider or a visibility/observability tool provider. Examples of the container vendor may include, but are not limited to, a virtual network function, VNFc vendor, a vendor providing observability tool for monitoring collection of the information related to the tenant container, an endpoint detection and response, EDR, provider/system, and so on. Examples of the tenant may include, but are not limited to, a MNO, a data broker, a 3^{rd} Generation Project Partnership, 3GPP function, network data analytics function, NWDAF, and so on. In some examples, the at least one external entity authenticated by the container vendor may include an external EDR system.

The collection agent 60 may be implemented as a pluggable module that can be integrated to the tenant container. In some examples, the container vendor associated with the tenant container 80 may integrate the collection agent 60 with the tenant container 80. Optionally, the collection agent 60 may be easily integrated with the tenant container 80 without extensive updates of the tenant container 80. Thus, the tenant containers 80 used by the tenant may be easily monitored in conjunction with the container vendor. In addition, one or more input(s) to the collection agent 60 may be added as vendor specific information to obtain an “all-in-one” observability agent. In some examples, the collection agent 60 and the tenant container 80 may be developed by the same container vendor. As a result, the collection agent 60 may be adapted to each tenant container 80 provided by the container vendor, so that the container vendor of each tenant container may create their own implementation of the collection agent 60. In some examples, the collection agent 60 may also be implemented as an open standardized plug-in interface towards and from the tenant container 80, which thereby can be a third party secure environment/TEE certified component.

Due to implementation of the pluggable collection agent 60, the container vendor may easily integrate the collection agent 60 with the tenant container 80. Also, it may be easy for the container vendor to review and configure the collection agent 60, which adds value not only for the tenant container 80 but also for the container vendor. In some examples, the vendor of the collection agent 60 may include at least one of: a virtual network function VNFc vendor, a vendor providing observability tool for monitoring collection of the information related to the tenant container, an EDR, provider/system. For instance, the EDR provider may develop fifth generation, 5G network functions i.e., VNF_{CS}.

For monitoring collection and transmission of the information of the tenant container 80 from the secure environment 90, the collection agent 60 is adapted to obtain configuration information identifying which information related to the tenant container 80 is to be collected within the secure environment 90 and transmitted from the secure environment 90.

In some examples, the collection agent 60 may obtain the configuration information by identifying, from a set of predetermined configuration rules, one or more configuration settings to be applied for collection, filtering and transmission of the information related to the tenant container 80 from the secure environment 90. The set of predetermined configuration rules may comprise an information type of the information related to the tenant container 80 to be collected, information identifying at least a part of the collected information to be filtered, and information identifying the at least one network entity 104 for transmission of the filtered information. Thus, the configuration rules may be used to protect sensitive information (for example, PII, IPR related information, or the like) leaving from the secure environment 90.

The information type may be a standard information/internal information/internal collection defined within the tenant container 80. In some examples, the internal information defines one or more of: information leaving the secure environment 90, information shared internally among the one or more processes executed by the computing device 102, information inflowing and leaving the secure environment 90, information about access control violation of the tenant container 80, information about unexpected network access of the tenant container 80, information about unexpected execution in the tenant container 80, information about unexpected write in the tenant container 80, and information about unexpected access rights in the tenant container 80. Optionally, the configuration enabling or disabling of collection of the internal information may be indicated in the configuration information received from the one or more network entities 104.

In some examples, the information may be an input of information collected inside the tenant container 80, external to the collection agent 60.

In some embodiments, as depicted in FIG. 2A, the collection agent 60 may receive the set of predetermined configuration rules from one or more of: the one or more network entities 104a and 104b, an internal source residing within the secure environment 90, and the at least one external entity in communication with the computing device 102.

In some examples, the collection agent 60 may receive the set of predetermined configuration rules from the one or more network entities 104a and 104b in different steps. For example, the collection agent 60 may receive the at least one predetermined configuration rule from a first network entity 104a, for example, the container vendor. Later, the collection agent 60 may receive adaptations, from a second network entity 104b, for example, the tenant, for the at least one predetermined configuration rule received from the container vendor. The adaptations may include removal of the at least one predetermined configuration rule defined by the first network entity 104a. For example, the adaptations may typically decrease the amount of information that is to be collected from the container. In some examples, the filtering rules can be received and/or added by the second network entity 104b . . . . Thus, equilibrium between the container vendor and the tenant is created in providing the configuration rules. For example, the collection agent 60 may implement the container vendor agnostic configuration settings on the different kind of information, for example, the container vendor specific information/input streams, collected from the tenant container 80 or the functionality of the tenant container 80. Some of the collected information may be destined for the container vendor, or an actor/the at least one external entity authenticated by the container vendor, while other may configured by the tenant to be destined for the tenant/MNO. Also, the collection agent 60 may implement the configuration settings based on the configuration rules provided by the MNO to remove the sensitive information from the information destined for the MNO or destinations (the external entities) pointed out by the tenant as well as for the information destined for the container vendor. Thus, the container vendor may protect the sensitive information and may specify destinations for each information. At the same time, the MNO may configure the destination and extraction of visibility information from the available information for its specific needs, all while maintaining benefits of the secure environment.

In some examples, the collection agent 60 may authenticate the at least one external entity for receiving the set of predetermined configuration rules. In some examples, the collection agent 60 may use credentials of approved external entities for authenticating the at least one external entity. Examples of the credentials of the approved external entities may include, but are not limited to, certificates of the approved external entities, or the like.

Thus, the collection agent 60 may use the configuration information/configuration settings to prune the information related to the tenant container 80 from sensitive information and prevent such information from leaving the secure environment.

Upon obtaining the configuration information (that is identifying the one or more configuration rules), the collection agent 60 may derive configuration settings for collection, filtering and transmission of the information related to the tenant container 80 from the secure environment 90. In some embodiments, the collection agent 60 may derive the configuration settings based on at least one of: the identified one or more configuration rules and one or more attributes, as depicted in FIG. 2B.

The configuration settings may comprise collection settings for collecting the information related to the tenant container, filtering settings for filtering the collected information, and transmission settings for transmission of the filtered information.

In some examples, the one or more attributes comprise one or more of: an identity, a location, and an owner of at least one of: the at least one network entity 104, the computing device 102, and the remote device in connection between the at least one network entity 104, and the computing device 102, tags and/or structure of the information to be collected, a functionality of the tenant container, a functionality of the one or more processes of the tenant container 80, and time and date.

Upon deriving the configuration settings, the collection agent 60 monitors collection, filtering and transmission of the information related to the tenant container 80 from the secure environment 90 using the configuration settings. The collection agent 60 comprises a collection module 52, a filtering module 54, and a transport protection and authentication module 56 for monitoring collection, filtering and transmission of the information related to the tenant container 80 from the secure environment 90.

The collection module 52 is adapted to collect the information related to the tenant container 80 during execution of the one or more processes 70 of the tenant container 80 within the secure environment 90. In some examples, if the secure environment 90 comprises its own kernel and the kernel supports probing (for example, Extended Berkeley Packet Filter, eBPF, probing), the collection module 52 may use one or more probes to collect the information related to the tenant container 80 when the one or more processes 70 of the tenant container is executed. In some examples, if the secure environment 90 does not comprise its own kernel, the collection module 52 may use an library operating system, OS, to collect the information related to the tenant container 80, when the tenant container 80 can be standardized to use the library OS.

For collecting the information related to the tenant container 80, the collection module 52 may identify the information type of the information related to the tenant container 80 to be collected using the collection settings. The collection module 52 may then collect the identified information type of the information related to the tenant container 80.

In some examples, the collection module 52 may collect the information, which can typically be connected to a particular process or functionality like transport decryption and encryption of incoming and outgoing data, for example, a same kind of information collected from the tenant container hosted in a non-secure environment. In some other examples, the collection module 52 may collect the information internally shared among the processes 70 of the tenant container 80 executed within the secure environment. Such internal information may be collected for threat detection similar to classical EDR functionality like observing different processes interaction with each other inside of the tenant container 80. Also, such internal information may be collected by the collection module 52 itself, for instance, using mechanisms similar to mechanisms of the EDR functionality. In some examples, the collected information may be used by a broker/tenant. In some examples, the collected information may be used for performing container vendor specific health checks on the functionality of the tenant container 80.

The filtering module 54 is adapted to filter the collected information. In some embodiments, for filtering the collected information, the filtering module 54 identifies at least a part of the collected information to be filtered using the derived filtering settings. The filtering module 54 may filter the identified information.

In some embodiments, the filtering module 54 may determine whether to transmit the collected information to be filtered at the external secure entity authenticated by the computing device 102. In some examples, the filtering module 54 may determine whether to transmit the collected information to be filtered at the external entity authenticated by the computing device 102, when the filtering module 54 may not be able to filter the information due to performance. When it has been determined to transmit the collected information, the filtering module 54 transmits the collected information with the configuration rules to be applied for filtering of the collected information and the attributes to the external entity via the transport protection and authentication module 506 for filtering.

The transport protection and authentication module 56 is adapted to transmit the filtered information to the at least one external entity 104. The transport protection and authentication module 56 may encrypt the filtered information for transmitting to the at least one network entity 104.

In some examples, the transport protection and authentication module 56 may transmit the filtered information to the at least one external entity 104 directly over the network. In some examples, the transport protection and authentication module 56 may transmit the filtered information to the at least one external entity 104 through the remote device/intermediator using a secure channel, for example, TLS. In some examples, the remote device/intermediator may be related to the collection agent 60.

In some embodiments, the transport protection and authentication module 56 may also be adapted to determine whether the at least one network entity 104 requires verification of the tenant container 80 and/or the secure environment 90 for receiving the information related to the tenant container 80 from the secure environment 90. When it has been determined that the at least one network entity 104 requires verification, the transport protection and authentication module 56 may transmit an identity of the tenant container 80 or an identity of the secure environment 90 to the at least one network entity 104. In some examples, the transport protection and authentication module 56 may transmit the identity of the secure environment 90 to the at least one network entity 104, when the identity of the tenant container 80 is not available at the transport protection and authentication module 56, or the identity of the tenant container 80 is not acceptable by the at least one network entity 104.

In some examples, the identity of the tenant container 80 may include a secondary identity of the tenant container 80. In some examples, the identity of the secure environment 90 may include a version of the secure environment, a digest or a version or a signer of the secure environment protected (parts of the) tenant container 80.

Thus, embodiments herein enable needed visibility from inside of the secure environment protected tenant container 80 without extracting sensitive information from the tenant container 80.

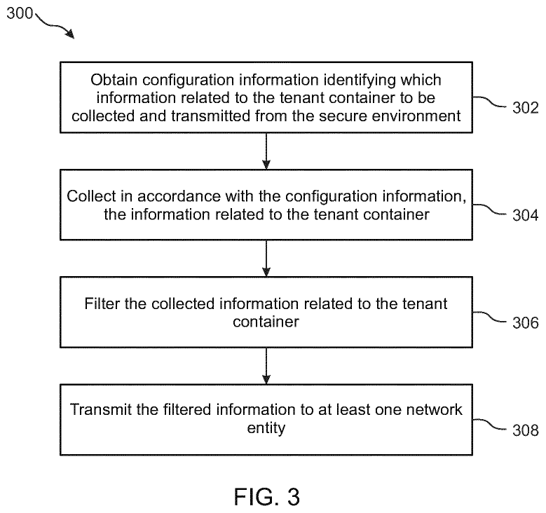

FIG. 3 is a flowchart illustrating example method steps of a method 300 performed within the tenant container executed by the computing device for monitoring the tenant container executed within the secure environment resident on the computing device.

At step 302, the method 300 comprises obtaining configuration information identifying which information identifying which information related to the tenant container is to be collected within the secure environment and transmitted from the secure environment.

In some embodiments, the step 302 of obtaining the configuration information may comprise identifying, from a set of predetermined configuration rules, one or more configuration rules to be applied for collection, filtering and transmission of the information.

Optionally, the set of predetermined configuration rules may be received from one or more of: the one or more network entities, an internal source residing within the secure environment, and at least one external entity in communication with the computing device.

In some examples, the method 300 may further comprise authenticating the at least one external entity using credentials of approved external entities for receiving the set of predetermined configuration rules.

In some examples, the step of receiving the set of predetermined configuration rules from the one or more network entities may comprise receiving, from a first network entity, at least one predetermined configuration rule and receiving, from a second network entity, adaptations to the at least one predetermined configuration rule received from the first network entity.

In some examples, the set of predetermined configuration rules may comprise an information type of the information related to the tenant container to be collected, information identifying at least a part of the collected information to be filtered, and information identifying the at least one network entity for transmission of the filtered information.

In some examples, the information type defines one or more of: information leaving the secure environment, information shared internally among the one or more processes, information inflowing and leaving the secure environment, information about access control violation of the tenant container, information about unexpected network access of the tenant container, information about unexpected execution in the tenant container, information about unexpected write in the tenant container, and information about unexpected access rights in the tenant container. In some examples, the information type may be an internal information defined within the tenant container, wherein enabling or disabling of collection of the internal information may be indicated in the configuration information.

The information type may be an input of information defined external to the tenant container by the one or more network entities.

In some embodiments, the method 300 further comprise deriving configuration settings for collection, filtering and transmission of the information related to the tenant container from the secure environment using at least one of: the configuration rules identified to be applied for collection, filtering and transmission of the information and one or more attributes.

In some examples, the configuration settings may comprise: collection settings for collecting the information related to the tenant container, filtering settings for filtering the collected information, and transmission settings for transmission of the filtered information.

In some examples, the one or more attributes may comprise an identity, a location, and an owner of at least one of: the at least one network entity, the computing device, and the remote device in connection between the computing device and the at least one network entity, tags and/or structure of the collected information, a functionality of the tenant container, a functionality of the one or more processes of the tenant container, and time and date of collection of the information.

At step 304, the method 300 comprises collecting, in accordance with the configuration information, the information related to the tenant container during execution of the one or more processes of the tenant container within the secure environment.

The step 304 of collecting the information related to the tenant container may comprise identifying the information type of the information related to the tenant container to be collected using the collection derived settings from the configuration information/configuration rules and the one or more attributes. The method 300 may comprise collecting the identified information type of the information related to the tenant container.

Upon collecting the information related to the tenant container, at step 306, the method 300 comprises filtering the collected information. In some embodiments, the step 306 of filtering the collected information may comprise identifying at least a part of the collected information to be filtered using the filtering settings derived from the configuration information/configuration rules and the one or more attributes. The method 300 may comprise filtering the identified information.

Optionally, the method 300 may further comprise determining, using the transmission settings, the at least one network entity for transmission of the filtered information.

Optionally, the method 300 may further comprise determining whether to transmit the collected information to be filtered at the secure external entity authenticated by the computing device. When it has been determined to transmit the collected information, the method 300 may comprise transmitting the collected information with the configuration rules to be applied for filtering of the collected information and the attributes to the external entity for filtering.

Upon filtering the collected information, at step 308, the method 300 comprises transmitting the filtered information to the at least one network entity. In some embodiments, the step 308 of transmitting the filtered information may comprise identifying the at least one network entity for transmission of the filtered information using the transmission settings derived from the configuration information/rules and the one or more attributes. The method 300 may comprise transmitting the filtered information to the identified at least one network entity. In some examples, the step of transmitting the filtered information to the identified at least one network entity may comprise encrypting the filtered information for transmitting to the at least one network entity.

The method 300 may further comprise determining whether the at least one network entity requires verification of the tenant container and/or the secure environment for receiving the information related to the tenant container from the secure environment. When it has been determined that the at least one network entity requires verification, the method 300 may comprise transmitting an identity of the tenant container or an identity of the secure environment to the at least one network entity.

In some examples, the network entity may comprise one or more of: a container vendor associated with the tenant container, a tenant, one or more processes external to the secure environment and being executed by the computing device, and at least one external entity authenticated by the container vendor.

Embodiments herein describe the configuration settings based on the information/rules received for monitoring of the tenant container executed within the secure environment using table 1.

TABLE 1
(Configuration settings based on the configuration rules)

| | | Transport |
|---|---|---|
| Collect | Filter | destination |
| Input stream 1 | PII 1, PII 3, PII 4 | Vendor |
| Input stream 2 | PII 1, PII 5 | MNO: Broker A, |
| | | Broker B |
| Ingoing and outgoing data | PII1, PII 2, PII 4, PII 5 | MNO: Broker A, |
| | | Broker B |
| Detect write to binary, | PII1, PII 2, PII 4, PII 5 | Vendor |
| access control violation, | | |
| unexpected network access | | |

The collection agent integrated with the tenant container obtains the configuration information (i.e., the collection agent may be configured) for monitoring the tenant container executed within the secure environment. Herein, obtaining the configuration information involves identifying, from a set of predetermined configuration rules, one or more configuration rules to be applied for collection, filtering and transmission of the information. The configuration rules comprise an information type of the information related to the tenant container to be collected, information identifying at least a part of the collected information to be filtered, and information identifying the at least one network entity for transmission of the filtered information.

The collection agent receives the set of predetermined configuration rules from the container vendor and the MNO for monitoring the tenant container executed within the secure environment. In some examples, the configuration rules provided by the container vendor have to be agreed/approved by the tenant/MNO. At the same time, the MNO may add additional configuration rules, like preferred filtering, or remove the at least one configuration rule provided by the container vendor. It should be noted that the collection agent may also receive configuration information from one or more of: the internal source residing within the secure environment, and the at least one external entity in communication with the computing device.

The configuration rules received from the container vendor and the MNO for collection, filtering and transmission of the information related to the tenant container is depicted in table 1.

In some examples, as depicted in table 1, the container vendor specifies the collection agent about the input stream 1 and the input stream 2 to be collected. The input stream 1 may be required to be collected for monitoring a functionality of the tenant container at the container vendor, for example, for tracking of process calls. The destination/transport destination of the input stream 1 may be the container vendor. For example, the input stream 1 collected may be filtered and transport encrypted for the container vendor, since the input stream 1 comprises data used by the container vendor to monitor an internal health and performance of the tenant container or the associated NF. In some examples, the destination of the input stream 1 may also be the at least one external entity trusted/authenticated by the container vendor. In addition, if the input stream 1 comprises sensitive information owned by the MNO, the collection agent may filter the input stream 1 according to the configuration rules received from the MNO.

For example, the input stream 2 corresponds to internal collection of information. The destination of the input stream 2 may be one or more brokers of the MNO. Similar to the input stream 1, the collection agent may filter the input stream 2 from the sensitive information like PII, before leaving the secure environment.

The collection agent may also perform its own information collection. For example, information inflowing and outgoing the secure environment (i.e., ingoing and outgoing data) is the information collection specified by the collection agent. The destination of the information inflowing and outgoing the secure environment may be typically the MNO, for instance in form of different data brokers. Similar to the input streams 1 and 2, the collection agent may filter the information inflowing and outgoing the secure environment.

The collection agent may also comprise one or more EDR functionalities like registration of write to binary files, detecting access control violations, detecting unexpected network configurations, and so on. The destination of such information may be the container vendor or the at least one external entity authenticated by the container vendor, since such information is related to the functionality of the tenant container and may reveal IPR of such information. The configuration rules for the information comprising the EDR functionalities may be received from the container vendor to optimize it towards an actual functionality of the tenant container.

The configuration rules for collection, filtering and transmission of the input stream 2 and the information inflowing and outgoing the secure environment may be received from the MNO or any external entity alternatively set by the MNO. The collection agent may receive such configuration rules from the MNO using a trusted interface exists between the MNO and the tenant container residing in the secure environment. The configuration rules for collection, filtering and transmission of the input stream 1 and the information related to the EDR functionality may be received from the container vendor. Also, the configuration rules for collection, filtering and transmission of the input stream 1 and the information comprising the EDR functionalities may be updated by the MNO. For example, the collection agent may receive the configuration rules in two phases of which a first one is set by the container vendor and a second one is set by the MNO.

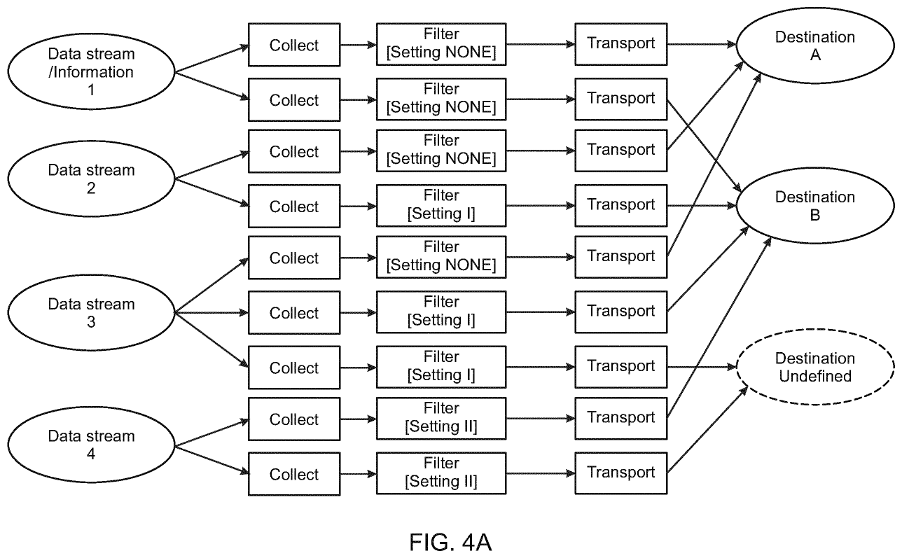

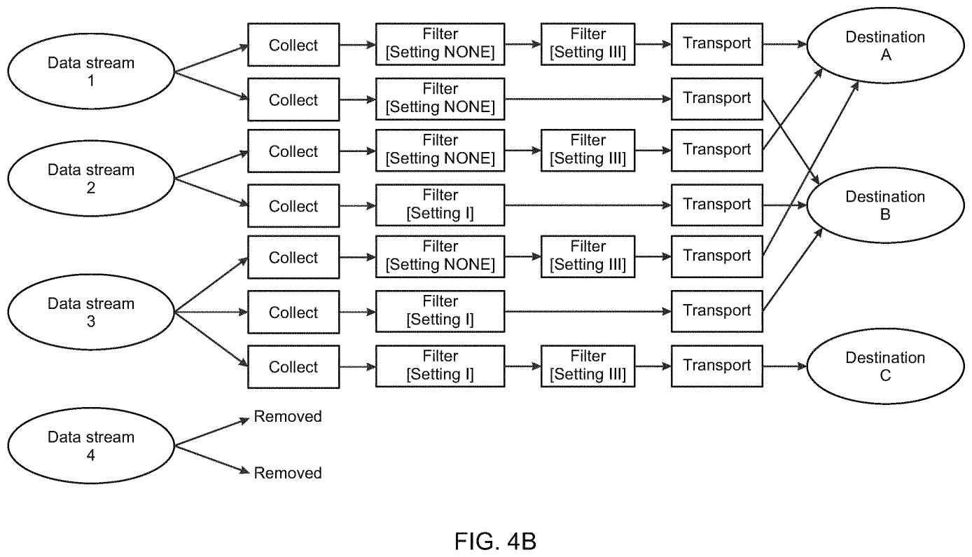

FIGS. 4A and 4B disclose example illustrations of configuration information received from the container vendor and the tenant, respectively, for collection and transmission of information from the secure environment.

The collection agent receives the set of predetermined configuration rules from the container vendor and the MNO for monitoring the tenant container executed within the secure environment in different phases. For example, in a first phase/phase 1, the collection agent receives the set of predetermined configuration rules from the container vendor. In a second phase/phase 2, the collection agent receives, from the tenant/MNO, adaptations to the set of predetermined configuration rules received from the container vendor

The configuration settings based on the configuration rules received from the container vendor for the information/data streams 1-4 in the phase 1 are depicted in FIG. 4A and table 2A.

TABLE 2A
(Configuration settings based on the configuration
rules received from container vendor)

| | | Transport |
|---|---|---|
| Collect | Filter | destination |
| Ingoing and outgoing data | None, None | Vendor, MNO |
| Input stream 1 (internal | None, Setting I | Vendor, MNO |
| tapping point 1) | | |
| Detect write to binary/access | None, Setting I, Setting I | Vendor, MNO, |
| control violation/unexpected | | Undefined |
| network access | | |
| Input stream 2 (internal | Setting II, Setting II | MNO, |
| tapping point 2) | | Undefined |

As depicted in FIG. 4A, and table 2, for each collected information/data stream, filters have to be applied (which can be none) and destination has to be set.

A data stream 1/ingoing and outgoing data may be a monitoring of information inflowing and outgoing from the secure environment (in and out data). A data stream 2/input stream 1 may be an internal tapping point of the tenant container. The internal tapping point of the tenant container can be an internal probe set inside the VNFc functionality to tap out internal data which can be used for Lawful intercept or even error detection. A data stream 3 may include an EDR functionality like monitoring the functionality of the tenant container (for example, detecting write to binary files, access control violation, unexpected network access, or the like). A data stream 4/input stream 2 may be an additional tapping point, which may or may not be in interest for the MNO. Setting I and setting II indicate sensitive information, for example, IPR related information, to be filtered from the collected input/data streams, thereby protecting the tenant container which sensitive functionality can have been delivered as a locked part encrypted to the tenant and is decrypted only inside of the by the vendor trusted secure environment. Destinations defined for the data streams 1, 2, and 3 may include a destination A and a destination B. The destination A may be the container vendor and the destination B may be the MNO.

The configuration settings based on the configuration rules received from the tenant/MNO for the information/data streams 1-4 in the phase 2 are depicted in FIG. 4B and table 2B.

TABLE 2B
(Configuration settings based on the configuration rules received from
the container vendor and the ones received from the tenant/MNO)

| | | Transport |
|---|---|---|
| Collect | Filter | destination |
| Ingoing and outgoing data | Setting III, None | Vendor, MNO |
| Input stream 1 (internal | Setting III, Setting I | Vendor, MNO |
| tapping point 1): | | |
| Detect write to binary/ | Setting III, Setting I, | Vendor, MNO, |
| access control violation/ | Setting I + Setting III | External EDR |
| unexpected network access | | |

As depicted in FIG. 4B, and table 4B, the collection agent may receive updated configuration rules/adaptations from the MNO in the phase 2. In some examples, the updated configuration rules may include additional configuration rules for filtering of the data streams/input streams destined for the container vendor to remove sensitive information from the collected data streams/input streams. In some examples, the data streams/input streams including the EDR functionality like monitoring the functionality of the tenant container (for example, detecting write to binary files, access control violation, unexpected network access, or the like) may be handled by the external entity. In such a case, the MNO may add additional configuration rules (for example, setting III) for filtering of the sensitive information from the data streams/input streams including the EDR functionality. A step of adding additional configuration rules may be handled internally by the MNO and the data streams/input streams for a destination C may be excluded. As depicted in FIG. 4B, and table 2B, the MNO's rules may remove the configuration settings for collection and transmission of the data stream 4/input stream 2, since the MNO does not have interest in the data stream 4/input stream 2.

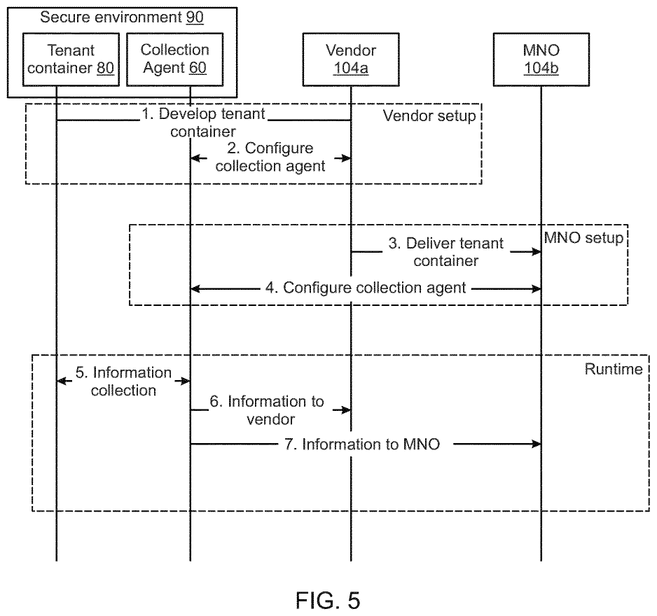

FIG. 5 is a signaling diagram illustrating example signaling for configuring the collection agent to monitor the tenant container executed within the secure environment resident on the computing device.

The container vendor 104a creates/develops (1) the tenant container 80 for execution within the secure environment 90, for example, a TEE.

The container vendor 104a integrates the collection agent 60 with the tenant container 80 and configures (2) the collection agent 60. Configuring the collection agent 60 by the container vendor 104a involves receiving by the collection agent 60 the set of predetermined configuration rules from the container vendor 104a. In some examples, integrating the collection agent 60 with the tenant container 80 optionally includes connecting of internal information representing NFs to different interfaces of the collection agent 60 creating information/data streams. The set of predetermined configuration rules identifies which information/data streams related to the tenant container 80 to be exclusively available to the container vendor 104a, and the tenant/MNO 104b. Also, the set of predetermined configuration rules identifies at least a part of the information, for example, IPR related information, PII, or the like, to be filtered before making it available to the container vendor 104a and the MNO 104b.

The container vendor 104a delivers (3) the tenant container 80 to the MNO 104b.

The MNO 104b, in accordance with its requirements, configures (4) the collection agent 60 by updating/altering the set of predetermined configuration rules provided by the container vendor 104a. The requirements of the MNO 104b may indicate different preferences on what information the MNO 104b require from the different NFs implemented using the tenant container 80. Thus, the MNO 104b may configure the collection agent 60 without the container vendor 104a perturbing about its sensitive information embedded in vendor locked parts of the secure environment 90. The MNO 104b may also specify the destination for each information/data stream related to the tenant container 80. For example, the destination specified by the MNO 104b may include data brokers or other destinations at the MNO 104b. The MNO 104b may also provide the set of predetermined configuration rules for filtering of the information/data streams terminating at the container vendor ensuring no MNO sensitive information leaves the MNO.

Upon being configured (i.e., on receiving the set of predetermined configuration rules), the collection agent 60 extracts (5) the information related to the tenant container 80 (representing the NF) by identifying the one or more configuration settings from the set of predetermined configuration rules.

After collection, the collection agent 60 filters the collected information based on the configuration rules provided by the container vendor 104a during the step 2 and based on the configuration rules provided by the MNO 104b during the step 4. The collection agent 60 transmits (6) the filtered information to the container vendor 104a. The collection agent 60 transmits (7) the filtered information to the MNO 104b.

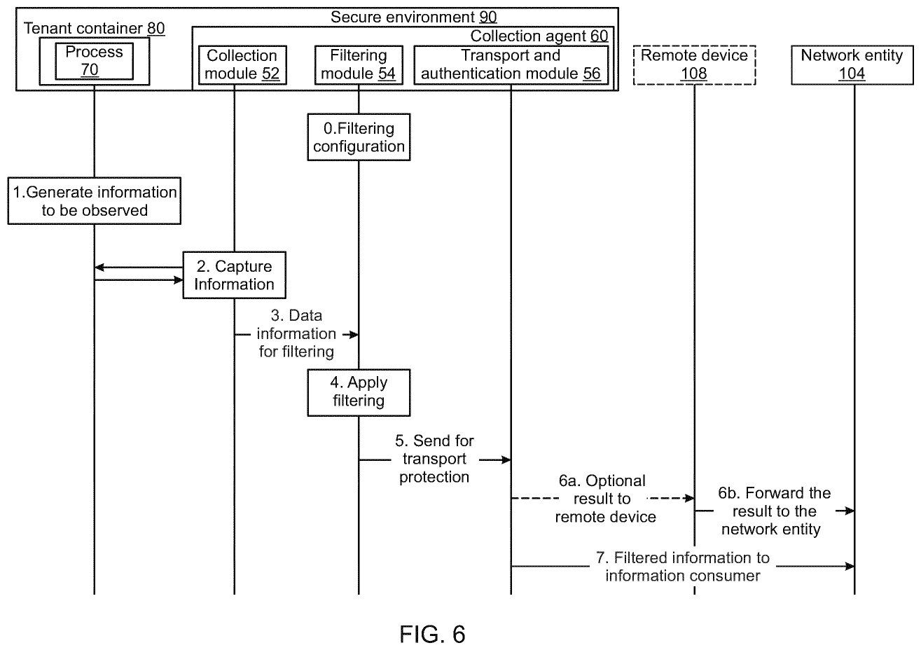

FIG. 6 is a signaling diagram illustrating example signaling for monitoring the tenant container 80 executed within the secure environment 90 resident on the computing device.

The collection agent receives (0) the set of predetermined configuration rules/filtering rules from one or more of: the one or more network entities 104, an internal source residing within the computing device/secure environment, and the at least one external entity authenticated by the computing device. The set of predetermined configuration rules may indicate an information type of the information related to the tenant container 80 to be collected, what information (i.e., at least a part of the collected information) to be filtered, and the at least one network entity/destination 104 for the filtered information. In some examples, the at least one network entity/destination 104 may include one or more of: the container vendor associated with the tenant container 80, the tenant/MNO, the one or more processes external to the secure environment 90, and the at least one external entity authenticated by the container vendor and/or the tenant.

In some embodiments, the collection agent derives the configuration settings based on at least one of: the identified one or more configuration rules and the one or more attributes related to at least one of: the computing device/hosting device, the at least one network entity 104, the remote device 108, the tenant container, the information to be collected, and a current time and data. The configuration settings may comprise collection settings for collecting the information related to the tenant container 80, the filtering settings for filtering the collected information, and the transmission settings for transmission of the filtered information.

The tenant container 80 generates (1) the information to be monitored, when the one or more processes 70 of the tenant container 80 are executed within the secure environment 90. In some examples, the process 70 may be a library implementing TLS and monitoring may be to capture clear text data before the information is encrypted for external communication.

The collection module 52 of the collection agent 60 collects (2) the generated information in accordance with the collection settings derived from the configuration rules and/or the attributes. In some examples, the collection agent 60 may use one or more probes to collect the information, if the secure environment 90 comprises its own kernel. In some examples, the collection agent 60 may use a library OS to collect the information, if the secure environment 90 does not comprise its own kernel. The collection module 52 forwards (3) the collected information to the filtering module 54 of the collection agent 60.

The filtering module 54 identifies (4) at least a part of the collected information to be filtered using the filtering settings derived from the configuration rules and/or the attributes. The filtering module 54 filters the identified information. The filtering module 54 forwards (5) the filtered information to the transport protection and authentication module 56 of the collection agent 60.

The transport protection and authentication module 56 identifies the at least one network entity 104 using the transmission settings derived from the configuration rules and/or the attributes. The transport protection and authentication module 56 transmits the filtered information to the identified at least one network entity 104.

In some examples, optionally, the transport protection and authentication module 56 forwards (6a) the filtered information/results/output to the remote device/intermediator 108 over a secure channel, for example, a TLS. The remote device 108 may be an intermediate node. For instance, the intermediate node may be the external entity implemented by the same or different provider as the collection agent 60. The remote device 108 handles the collection of the information from different nodes (collection agents) and forwards (6b) the information complied to the at least one network entity 104. In addition, the remote device 108 may also handle authentication of different nodes, like authentication of the secure environment 90 comprising the collection agent 60.

In some examples, the transport protection and authentication module 56 transmits the filtered information to the at least one network entity 104 directly over the secure channel, for example, TLS.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

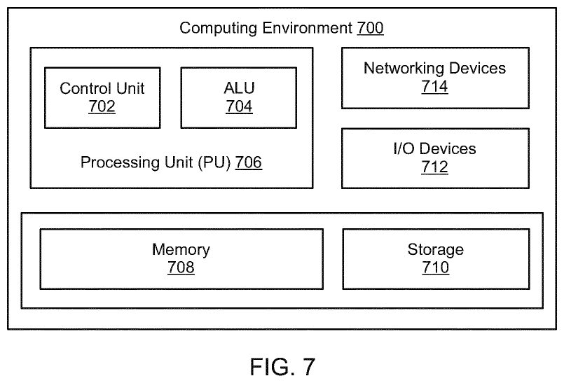

FIG. 7 illustrates an example computing environment 700 implementing a method and the computing device, as described in FIGS. 3 and 2A-2B. As depicted in FIG. 7, the computing environment 700 comprises at least one data processing module 706 that is equipped with a control module 702 and an Arithmetic Logic Unit (ALU) 704, a plurality of networking devices 714 and a plurality Input output, I/O devices 712, a memory 708, a storage 710. The data processing module 706 may be responsible for implementing the method described in FIG. 3. For example, the data processing module 706 may in some embodiments be equivalent to the CPU/processor of the computing device described above in conjunction with the FIGS. 2A and 2B. The data processing module 706 is capable of executing software instructions stored in memory 708. The data processing module 706 receives commands from the control module 702 in order to perform its processing. Further, any logical and arithmetic operations involved in the execution of the instructions are computed with the help of the ALU 704.

The computer program is loadable into the data processing module 706, which may, for example, be comprised in an electronic apparatus (such as a computing device). When loaded into the data processing module 706, the computer program may be stored in the memory 708 associated with or comprised in the data processing module 706. According to some embodiments, the computer program may, when loaded into and run by the data processing module 706, cause execution of method steps according to, for example, any of the method illustrated in FIG. 3 or otherwise described herein.

The overall computing environment 700 may be composed of multiple homogeneous and/or heterogeneous cores, multiple CPUs of different kinds, special media and other accelerators. Further, the plurality of data processing modules 706 may be located on a single chip or over multiple chips.

The algorithm comprising of instructions and codes required for the implementation are stored in either the memory 708 or the storage 710 or both. At the time of execution, the instructions may be fetched from the corresponding memory 708 and/or storage 710, and executed by the data processing module 706.

In case of any hardware implementations various networking devices 714 or external I/O devices 712 may be connected to the computing environment to support the implementation through the networking devices 714 and the I/O devices 712.

The embodiments disclosed herein can be implemented through at least one software program running on at least one hardware device and performing network management functions to control the elements. The elements shown in FIG. 7 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1.-42. (canceled)

43. A computer-implemented method for monitoring a tenant container executed within a secure environment resident on a computing device, wherein the method is performed by a collection agent within the tenant container and comprises:
obtaining configuration information identifying which information related to the tenant container is to be collected within the secure environment and transmitted from the secure environment;
collecting, in accordance with the configuration information, the information related to the tenant container during execution of one or more processes of the tenant container within the secure environment;
filtering the collected information related to the tenant container; and
transmitting the filtered information to at least one network entity of a network to which the computing device is connected.

44. The method according to claim 43, wherein obtaining the configuration information comprises identifying, from a set of predetermined configuration rules, one or more configuration settings to be applied for collection and transmission of the information.

45. The method according to claim 44, wherein the set of predetermined configuration rules are received from one or more of the following:
one or more network entities of the network;
an internal source within the secure environment; and
at least one external entity in communication with the computing device.

46. The method according to claim 45, further comprising authenticating the at least one external entity using credentials of external entities approved for receiving the set of predetermined configuration rules.

47. The method according to claim 45, wherein receiving the set of predetermined configuration rules from the one or more network entities comprises:
receiving, from a first network entity, at least one of the predetermined configuration rules; and
receiving, from a second network entity, adaptations to the at least one predetermined configuration rule received from the first network entity.

48. The method according to claim 43, wherein the set of predetermined configuration rules comprises:
one or more types of the information related to the tenant container to be collected;
information identifying at least a part of the collected information to be filtered; and
information identifying the at least one network entity to which the filtered information is transmitted.

49. The method according to claim 48, wherein the one or more types of the information related to the tenant container to be collected include one or more of the following:
information shared internally among the one or more processes;
information inflowing and leaving the secure environment;
information about access control violation of the tenant container;
information about unexpected network access of the tenant container;
information about unexpected execution in the tenant container;
information about unexpected write in the tenant container; and
information about unexpected access rights in the tenant container.

50. The method according to claim 49, wherein:
the one or more types is internal information defined within the tenant container; and
the obtained configuration information indicates one or more of the following for collection of the internal information: configuration, enabling, and disabling.

51. The method according to claim 48, wherein the one or more types is an input of information collected inside the tenant container, external to the collection agent.

52. The method according to claim 43, further comprising deriving configuration settings for the information related to the tenant container from the secure environment based on at least one of the following:
a set of configuration rules for collection, filtering and transmission of the information; and
one or more attributes.

53. The method according to claim 52, wherein the derived configuration settings include one or more of the following:
collection settings for collecting the information related to the tenant container;
filtering settings for filtering the collected information; and
transmission settings for transmission of the filtered information.

54. The method according to claim 52, wherein the one or more attributes include one or more of the following:
identity, location, and owner of at least one of the following: the at least one network entity, the computing device, and a remote device in connection between the computing device and the at least one network entity;
tags and/or structure of the information to be collected;
functionality of the tenant container;
functionality of the one or more processes of the tenant container; and
time and date.

55. The method according to claim 53, wherein collecting the information related to the tenant container comprises:
identifying one or more types of the information related to the tenant container to be collected using the derived collection settings; and
collecting the identified one or more types of the information related to the tenant container.

56. The method according to claim 53, wherein filtering the collected information related to the tenant container comprises:
identifying at least a part of the collected information to be filtered using the derived filtering settings; and
filtering the identified information.

57. The method according to claim 56, further comprising determining, using the derived transmission settings, the at least one network entity to which the filtered information is to be transmitted.

58. The method according to claim 56, further comprising:
determining whether to transmit the collected information to be filtered at an external entity authenticated by the computing device; and
when it has been determined to transmit the collected information, transmitting the collected information to the external entity for filtering, wherein the collected information is transmitted together with the set of configuration rules and the one or more attributes.

59. The method according claim 53, wherein transmitting the filtered information comprises:
identifying the at least one network entity for transmission of the filtered information using the derived transmission settings; and
transmitting the filtered information to the identified at least one network entity.

60. A computing device comprising one or more processors operably coupled to one or more memories, wherein:
the one or more processors and the one or more memories are configured to implement a secure environment for execution of a tenant container that includes a collection agent; and
the one or more processors are further configured to execute the following operations by the collection agent:
obtain configuration information identifying which information related to the tenant container is to be collected within the secure environment and transmitted from the secure environment;
collect, in accordance with the configuration information, the information related to the tenant container during execution of one or more processes of the tenant container within the secure environment;
filter the collected information related to the tenant container; and
transmit the filtered information to at least one network entity.

61. A non-transitory, computer readable medium storing program instructions that, when executed by one or more processors, cause a collection agent to perform the computer-implemented method for monitoring a tenant container executed within a secure environment resident on a computing device, according to claim 43.
